(19) United States
(12) Patent Application Publication
(10) Pub. No.: US 2025/0314832 A1
(43) Pub. Date: Oct. 9, 2025

(54) OPTICAL WAVEGUIDE COMPONENT

(71) Applicant: SHINKO ELECTRIC INDUSTRIES CO., LTD., Nagano (JP)

(72) Inventor: Yuji FURUTA, Nagano (JP)

(21) Appl. No.: 19/095,363

(22) Filed: Mar. 31, 2025

(30) Foreign Application Priority Data
Apr. 5, 2024 (JP) 2024-061262

(51) Int. Cl. G02B 6/32; G02B 6/02

(52) U.S. Cl. CPC G02B 6/32; G02B 6/02033

(57) ABSTRACT

An optical waveguide component includes a substrate having a first principal surface, an optical waveguide provided on the first principal surface and including a first core, and a first optical connector fixed to the substrate and including a first collimating lens. A first distance between a first principal point of the first collimating lens and a first end surface of the first core is equal to a first focal distance of the first collimating lens.

### CROSS-REFERENCE TO RELATED APPLICATIONS

This application is based upon and claims priority to Japanese Patent Application No. 2024-061262, filed on Apr. 5, 2024, the entire contents of which are incorporated herein by reference.

### FIELD

Certain aspects of the embodiments discussed herein are related to optical waveguide components.

### BACKGROUND

Various techniques have been proposed for optically coupling an optical fiber to an optical waveguide provided on a substrate.

Related art include Japanese Laid-Open Patent Publication No. 2011-081299, Japanese Laid-Open Patent Publication No. 2015-114645, and A. Noriki et al., “Low-Cost MT-Ferrule-Compatible Optical Connector for Co-packaged Optics Using Single-Mode Polymer Waveguide”, Electronic Components and Technology Conference, 1 May 2019, for example.

It is difficult to obtain a high coupling efficiency between the optical waveguide and the optical fiber according to the conventional techniques.

### SUMMARY

Accordingly, it is an object in one aspect of the embodiments to provide an optical waveguide component capable of obtaining a high coupling efficiency between an optical waveguide and an optical fiber.

According to one aspect of the embodiments, an optical waveguide component includes a substrate having a first principal surface; an optical waveguide provided on the first principal surface and including a first core; and a first optical connector fixed to the substrate and including a first collimating lens, wherein a first distance between a first principal point of the first collimating lens and a first end surface of the first core is equal to a first focal distance of the first collimating lens.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a plan view illustrating an example of an optical waveguide component according to one embodiment;

FIG. 2 is a cross sectional view (part 1) illustrating the example of the optical waveguide component according to one embodiment; and

FIG. 3 is a cross sectional view (part 2) illustrating the example of the optical waveguide component according to one embodiment.

### DESCRIPTION OF EMBODIMENTS

Preferred embodiments of the present invention will be described with reference to the accompanying drawings. In the specification and the drawings, those parts that are the same are designated by the same reference numerals, and a redundant description thereof may be omitted.

### Configuration of Optical Waveguide Component

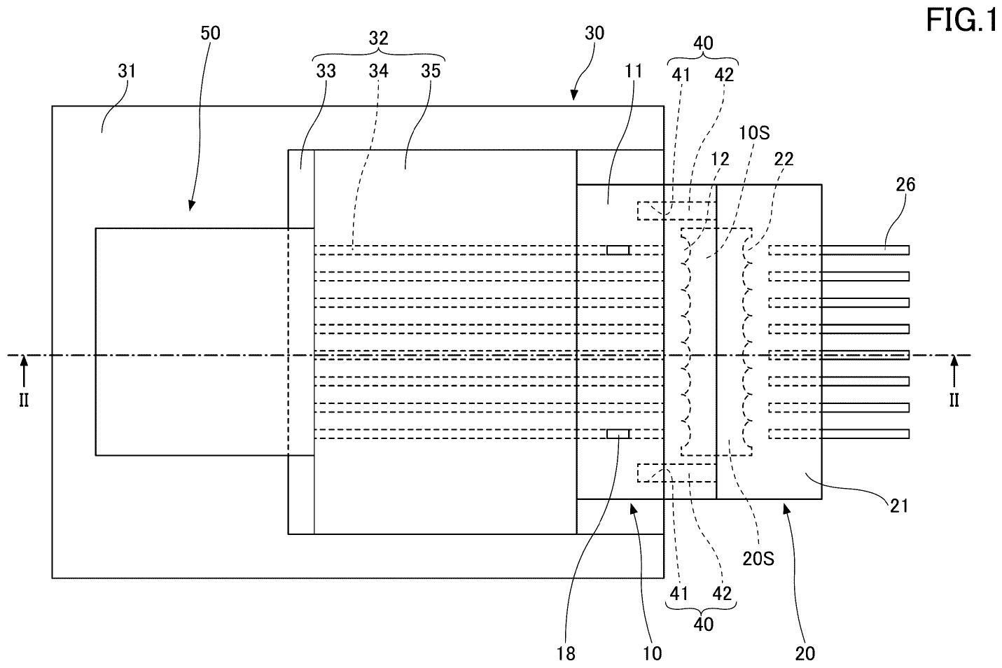

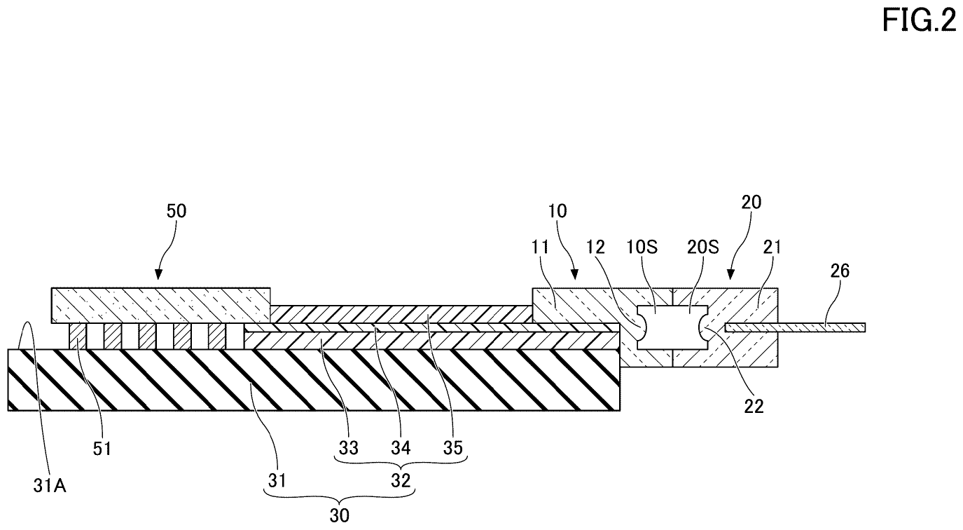

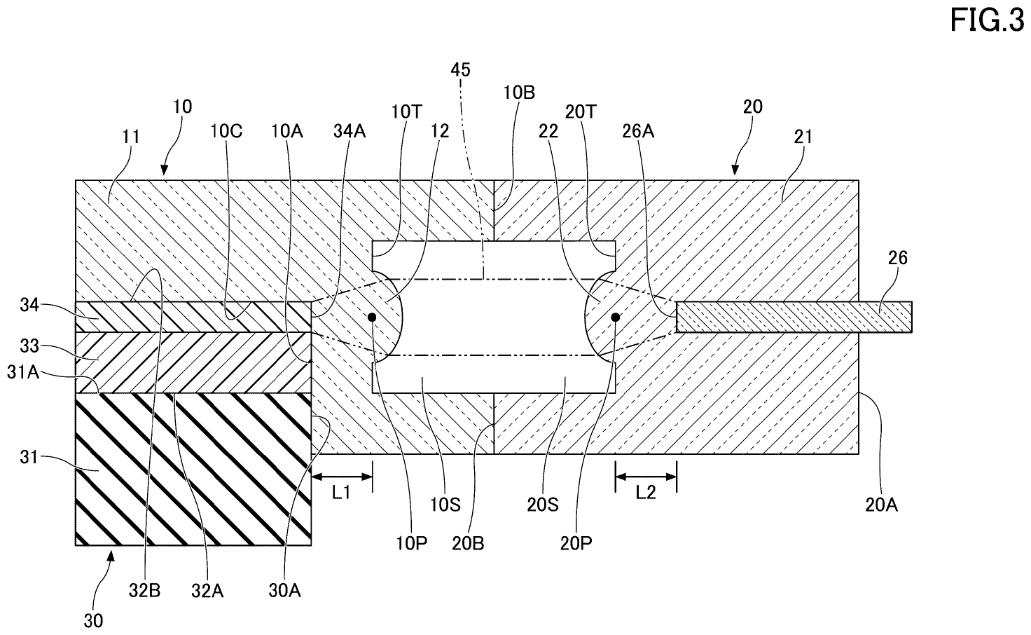

A configuration of an optical waveguide component according to one embodiment will be described. FIG. 1 is a plan view illustrating an example of the optical waveguide component according to one embodiment. FIG. 2 and FIG. 3 are cross sectional views illustrating the example of the optical waveguide component according to one embodiment. FIG. 2 corresponds to a cross sectional view taken along a line II-II in FIG. 1. FIG. 3 illustrates a part of FIG. 2 on an enlarged scale.

As illustrated in FIG. 1 through FIG. 3, an optical waveguide component 1 according to one embodiment includes an optical waveguide substrate 30, a first optical connector 10, a second optical connector 20, and an optical semiconductor chip 50.

The optical waveguide substrate 30 includes a substrate 31 and an optical waveguide 32.

The substrate 31 is a wiring board, for example, and includes one or more interconnect patterns (not illustrated) and electrodes (not illustrated). The optical waveguide 32 is provided on one principal surface 31A of the substrate 31. The principal surface 31A is an example of a first principal surface.

In the present embodiment, for the sake of convenience, an upper side or one side and a lower side or the other side of the optical waveguide component 1 are specified with reference to the substrate 31. More particularly, the side of the optical waveguide component 1 provided with the optical waveguide 32 is referred to as the upper side or the one side, and the opposite side of the optical waveguide component 1 not provided with the optical waveguide 32 is referred to as the lower side or the other side. An upper surface of each portion of the optical waveguide component 1 is referred to as one surface or an upper surface, and a lower surface of each portion of the optical waveguide component 1 is referred to as the other surface or a lower surface. However, the optical waveguide component 1 can be used in an upside-down state or can be arranged at an arbitrary angle. Further, a plan view of each portion of the optical waveguide component 1 refers to a view thereof viewed from above and in a normal direction to the principal surface 31A of the substrate 31. A planar shape of each portion of the optical waveguide component refers to the shape of the each portion in the plan view viewed from above in the normal direction of the principal surface 31A of the substrate 31.

The optical waveguide 32 includes a first cladding layer 33, a plurality of core layers 34, and a second cladding layer 35. The optical waveguide 32 is a polymer waveguide. The core layer 34 is an example of a first core.

The first cladding layer 33 is provided on the substrate 31. A material used for the first cladding layer 33 may be an organic resin, such as an epoxy resin, a polyimide resin, or the like, for example. A thickness of the first cladding layer 33 may be in a range of approximately 10 μm to approximately 30 μm, for example.

The plurality of core layers 34 are provided in a band shape on the first cladding layer 33. A material used for the core layers 34 may be an organic resin, such as an epoxy resin, a polyimide resin, or the like, for example. For example, a cross sectional shape of the core layer 34, perpendicular to an extending direction in which the core layer 34 extends, may be rectangular. In order to obtain a single-mode optical waveguide, the core layer 34 may have a very small cross sectional area. For example, a width of the core layer 34 may be in a range of 5 um to 10 μm, and a height of the core layer 34 may be in a range of 5 um to 10 μm.

The second cladding layer 35 is provided on the first cladding layer 33 and the plurality of core layers 34. The second cladding layer 35 covers the plurality of core layers 34. A material used for the second cladding layer 35 may be an organic resin, such as an epoxy resin, a polyimide resin, or the like, for example. A thickness of the second cladding layer 35 may be in a range of approximately 10 μm to approximately 30 μm, for example.

A portion of the core layer 34 may be exposed from the second cladding layer 35 on both sides of the core layer 34 in the extending direction.

In the optical waveguide 32, a refractive index of the core layer 34 is higher than refractive indexes of the first cladding layer 33 and the second cladding layer 35.

The optical semiconductor chip 50 includes an optical element (not illustrated), and is mounted on the substrate 31. The optical semiconductor chip 50 has a plurality of electrodes 51, and is flip-chip bonded to the substrate 31. The optical semiconductor chip 50 is disposed on one side of the core layers 34 along the extending direction, and the optical element is optically coupled to the optical waveguide 32. The optical element may be either a light receiving element or a light emitting element.

The optical waveguide substrate 30 has an end surface 30A disposed on the opposite side from the optical semiconductor chip 50 in the extending direction of the core layers 34. The end surface 30A includes each of first end surfaces 34A of the plurality of core layers 34. For example, the first end surface 34A is perpendicular to an optical axis of the core layer 34 to which the first end surface 34A belongs. Thus, each of the first end surfaces 34A of the plurality of core layers 34 is perpendicular to the optical axis of each of the plurality of core layers 34.

The first optical connector 10 includes a first glass member 11, and a plurality of first collimating lenses 12. For example, the first glass member 11 and the plurality of first collimating lenses 12 are integrally formed of glass. The first optical connector 10 has a first surface 10A in close contact with the first end surfaces 34A of the plurality of core layers 34. The first end surfaces 34A and the first surface 10A may be bonded to each other using a light-transmitting adhesive, for example.

A plurality of recesses 10S, recessed toward the first surface 10A, are formed in a second surface 10B on the opposite side from the first surface 10A of the first optical connector 10. The plurality of first collimating lenses 12 are provided at bottoms 10T of the plurality of recesses 10S, respectively. The number of first collimating lenses 12 is equal to the number of core layers 34. The plurality of first collimating lenses 12 are located on the optical axes of the plurality of core layers 34, respectively, and one first collimating lens 12 and one core layer 34 constitute a pair. In each pair of the first collimating lens 12 and the core layer 34, a first distance L1 between a first principal point 12P of the first collimating lens 12 and the first end surface 34A of the core layer 34 is equal to a first focal distance of the first collimating lens 12. A portion of the first glass member 11 is located between the first collimating lens 12 and the first surface 10A. A diameter of the first collimating lens 12 is approximately 100 μm, for example.

The optical waveguide 32 has a first surface 32A and a second surface 32B which connect to the end surface 30A. The first surface 32A makes contact with the principal surface 31A of the substrate 31, and the second surface 32B is located on the opposite side from the first surface 32A. The first and second surfaces 32A and 32B are parallel to the principal surface 31A. For example, the core layers 34 are exposed at the second surface 32B.

In addition, the second cladding layer 35 may be provided between the adjacent core layers 34, and this portion of the second cladding layer 35 provided between the adjacent core layers 34 may also be exposed at the second surface 32B.

The first optical connector 10 has a second surface 10C that is continuous with the first surface 10A and is in close contact with the second surface 32B of the optical waveguide 32. For example, an angle formed by the first surface 10A and the second surface 10C of the first optical connector 10 is 90 degrees. The second surface 32B of the optical waveguide 32 and the second surface 10C of the first optical connector 10 may be bonded to each other using a light-transmitting adhesive, for example.

The first optical connector 10 has alignment marks 18. The alignment marks 18 may be mechanically formed as recesses or the like, or may be formed by a color processing, such ion implantation or the like.

The second optical connector 20 includes a second glass member 21, a plurality of second collimating lenses 22, and a plurality of optical fiber cores 26. For example, the second glass member 21 and the plurality of second collimating lenses 22 are integrally formed of glass. The number of the second collimating lenses 22 and the number of the optical fiber cores 26 are equal to the number of the core layers 34 and the number of the first collimating lenses 12. The second glass member 21 can function as a cladding with respect to the optical fiber cores 26. The optical fiber cores 26 are an example of a second core.

The second optical connector 20 has a first surface 20A, and a second surface 20B located on the opposite side from the first surface 20A. The optical axes of the optical fiber cores 26 are parallel to one another among the plurality of optical fiber cores 26 in the second glass member 21. For example, the first and second surfaces 20A and 20B are perpendicular to the optical axes of the plurality of optical fiber cores 26 in the second glass member 21. The plurality of optical fiber cores 26 extend outward from the first surface 20A.

A plurality of recesses 20S, recessed toward the first surface 20A, are formed in the second surface 20B. The plurality of second collimating lenses 22 are provided at bottoms 20T of the plurality of recesses 20S, respectively. The plurality of second collimating lenses 22 are located on the optical axes of the plurality of optical fiber cores 26, respectively, and one second collimating lens 22 and one optical fiber core 26 constitute a pair. In each pair of the second collimating lens 22 and the optical fiber core 26, a second distance L2 between a second principal point 22P of the second collimating lens 22 and a second end surface 26A of the optical fiber core 26 is equal to a second focal distance of the second collimating lens 22. A portion of the second glass member 21 is located between the second collimating lens 22 and the second end surface 26A. A diameter of the second collimating lens 22 is approximately 100 um, for example.

The second optical connector 20 is attachable to and detachable from the first optical connector 10. When the second optical connector 20 is coupled to the first optical connector 10, the second surface 10B of the first optical connector 10 and the surface 20B of the second optical connector 20 oppose each other, and the plurality of recesses 10S and the plurality of recesses 20S connected to one another, respectively. The optical waveguide component 1 includes a constraining mechanism 40. The constraining mechanism 40 includes a plurality of fitting holes 41 provided in the second surface 10B, and a plurality of fitting pins 42 provided on the second surface 20B and fitted into the fitting holes 41, respectively. For example, the fitting holes 41 are located on both outer sides of the outermost recesses 10S located on the outermost sides in the direction in which the plurality of first collimating lenses 12 are arranged. Further, the fitting pins are located on both outer sides of the outermost recesses 20S located on the outermost sides in the direction in which the plurality of second collimating lenses 22 are arranged. The fitting pins 42 are fitted into the fitting holes 41, and thus, the first optical connector 10 and the second optical connector 20 are mechanically constrained from being positionally displaced from each other in directions parallel to the second surface 10B of the first optical connector 10 and the second surface 20B of the second optical connector 20. Each first collimating lens 12 of the plurality of first collimating lenses 12 opposes one second collimating lens 22 of the plurality of second collimating lenses 22 to constitute a pair of mutually opposing first and second collimating lenses 12 and 22, and a signal of collimated light 45 is transmitted between the pairs of mutually opposing first and second collimating lenses 12 and 22. Accordingly, the constraining mechanism 40 constrains the first optical connector 10 and the second optical connector 20 to each other in a direction perpendicular to an optical axis of the collimated light 45. Preferably, mode field diameters (MFDs) of the core layer 34 and the optical fiber core 26 match.

The positions of the fitting holes 41 and the fitting pins 42 are not particularly limited. The fitting holes 41 may be located on both sides of a row of the first collimating lenses 12 in the extending direction of the core layer 34, and the fitting pins 42 may be located on both sides of a row of the second collimating lenses 22 in an extending direction in which the optical fiber core 26 extends.

### Method for Manufacturing Optical Waveguide Component and Method for Using the Same

Next, a method for manufacturing the optical waveguide component according to the embodiment, and a method for using the optical waveguide component according to the embodiment, will be described.

First, the optical waveguide substrate 30 is prepared, and the optical semiconductor chip 50 is mounted on the substrate 31. Next, the first optical connector 10 is attached to the optical waveguide substrate 30. By providing the alignment marks 18 at positions overlapping specific core layers 34 in the plan view of the first optical connector 10, and aligning the positions of the alignment marks 18 with the core layers 34 visible through the first glass member 11, the alignment in the direction in which the core layers 34 are arranged can be easily performed in this state. In addition, by causing the first surface 10A of the first optical connector 10 to make close contact with the end surface 30A of the optical waveguide substrate 30, the alignment in the extending direction of the core layers 34 can be easily performed. Further, by causing the second surface 10C of the first optical connector 10 to make close contact with the surface 32B of the optical waveguide 32, the alignment in a thickness direction of the optical waveguide substrate 30 can be easily performed. The first optical connector 10 may be fixed to the optical waveguide substrate 30 using a light-transmitting adhesive, for example.

The optical waveguide component 1 is used by connecting the first optical connector 10 and the second optical connector 20 to each other. When connecting the first optical connector 10 and the second optical connector 20, the second optical connector 20 is pressed against the first optical connector 10 while fitting the fitting pin 42 into the fitting hole 41, respectively. Then, the second optical connector 20 is fixed to the first optical connector 10. The second optical connector 20 can be detachably fixed to the first optical connector 10 using a latch mechanism or the like, for example.

The optical waveguide component 1 according to the embodiment can be manufactured and used in the manner described above.

In the optical waveguide component 1, the collimated light 45 via the first collimating lens 12 and the second collimating lens 22 is used for transmitting the light between the core layer 34 and the optical fiber core 26. For this reason, a loss is small, and a coupling efficiency can be improved.

For example, a slight margin may exist between the fitting hole 41 and the fitting pin 42, the second principal point 22P of the second collimating lens 22 may be slightly deviated from the optical axis of the core layer 34, and the first principal point 12P of the first collimating lens 12 may be slightly deviated from the optical axis of the optical fiber core 26. Even if such deviations exist, the light emitted from the first collimating lens 12 is focused onto the second end surface 26A of the optical fiber core 26 and the light emitted from the second collimating lens 22 is focused onto the first end surface 34A of the core layer 34, by using the collimated light 45. Hence, the core layer 34 and the optical fiber core 26 can be optically coupled by passive alignment.

The second optical connector 20 may be composed of a plurality of components or constituent elements. For example, the second optical connector 20 may be configured by bonding a component including the optical fiber cores 26 having exposed end surfaces, and a component including the second collimating lenses 22, to each other.

According to the present disclosure, a high coupling efficiency can be obtained between an optical waveguide and an optical fiber.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide component comprising:
a substrate having a first principal surface;
an optical waveguide provided on the first principal surface and including a first core; and
a first optical connector fixed to the substrate and including a first collimating lens,
wherein a first distance between a first principal point of the first collimating lens and a first end surface of the first core is equal to a first focal distance of the first collimating lens.

2. The optical waveguide component as claimed in claim 1, wherein the first optical connector has a first surface in close contact with the first end surface of the first core.

3. The optical waveguide component as claimed in claim 2, wherein the first optical connector includes a first glass member located at least between the first collimating lens and the first surface.

4. The optical waveguide component as claimed in claim 1, wherein the optical waveguide is a polymer waveguide.

5. The optical waveguide component as claimed in claim 1, further comprising:
a second optical connector including a second collimating lens and detachably attached to the first optical connector,
wherein a signal of collimated light is transmitted between the first collimating lens and the second collimating lens.

6. The optical waveguide component as claimed in claim 5, wherein:
the second optical connector includes a second core of an optical fiber,
wherein a second distance between a second principal point of the second collimating lens and a second end surface of the second core is equal to a second focal distance of the second collimating lens.

7. The optical waveguide component as claimed in claim 6, wherein the second optical connector includes a second glass member located at least between the second collimating lens and the second end surface of the second core.

8. The optical waveguide component as claimed in claim 5, further comprising:
a constraining mechanism configured to constrain the first optical connector and the second optical connector to each other in a direction perpendicular to an optical axis of the collimated light.

9. The optical waveguide component as claimed in claim 1, further comprising:
an optical semiconductor chip mounted on the substrate and optically coupled to the optical waveguide.
